(19) United States
(12) Patent Application Publication
(10) Pub. No.: US 2010/0003376 A1
(43) Pub. Date: Jan. 7, 2010

(54) SAUSAGE CASING HAVING IMPROVED SAUSAGE EMULSION ADHESION

(75) Inventors: Klaus-Dieter Blumenberg, Walsrode (DE); Heinrich Henze-Wethkamp, Walsrode (DE); Willi Neuschulz, Bad Fallingbostel (DE)

Correspondence Address: CONNOLLY BOVE LODGE & HUTZ, LLP, P O BOX 2207, WILMINGTON, DE, 19899, US

(73) Assignee: Casetech GmbH & Co. KG, Walsrode (DE)

(21) Appl. No.: 12/497,068

(22) Filed: Jul. 2, 2009

(30) Foreign Application Priority Data
Jul. 3, 2008 (EP) 08011983.7

(51) Int. Cl. A22C 13/00; B05D 5/00; A23L 1/317

(52) U.S. Cl. 426/105; 428/34.8; 427/207.1

(57) ABSTRACT

The present invention relates to a food casing for sausage products, in particular to a tubular sausage casing based on cellulose having an internally applied coating composition and adhesion between filling and sausage casing improved thereby.

### RELATED APPLICATIONS

This application claims benefit to European Application No. 08 011 983.7 filed Jul. 3, 2008 which is incorporated by reference in its entirety for all useful purposes.

### BACKGROUND OF THE INVENTION

The invention relates to a food casing for sausage products, in particular to a tubular sausage casing based on cellulose having an internally applied coating composition and adhesion between filling and sausage casing improved thereby.

Tubular casings are widely used as packaging materials for foods and are used to a great extent for producing processed meat products such as sausage products. If the inside of such food casings is used untreated, it is observed that in sausage production, in particular raw cured sausage production, the sausage emulsion does not adhere firmly enough to the sausage casing. Consequently, partial detachment of the sausage from the sausage casing occurs, frequently combined with unwanted development of a fat film or gel film on the sausage product.

Because of the detachment, the food casing also no longer shrinks onto the filling, resulting in the sausage appearing creased and unsightly.

In order to eliminate these said disadvantages, it is proposed, e.g. in EP-A-88 308 and U.S. Pat. No. 3,378,379 to furnish the inside of the tubular food casing made of regenerated cellulose with a coating based on polyethyleneimine, chemically modified proteins, or epichlorohydrin, polyamine-polyamide, urea or melamine-formaldehyde resins.

Although this internal finishing of tubular food casings leads to an improvement in adhesion, it is not sufficient for all application purposes of cured raw sausage production. In addition, it is observed that tubular casings which are internally coated in this manner can stick together and as a result the opening and stuffing can be seriously impeded.

WO 2005/092108 A1 describes a tubular sausage casing based on cellulose having an internal impregnation which comprises at least one adhesion component and at least two release components. This is said to achieve the object of achieving sufficient adhesion over the entire ageing period of the sausage with simultaneous minimal adhesion of the casings during peeling. The adhesion component and one of the release components in this case is bound to the cellulose of the casing. As adhesion component, use is preferably made of casein, gelatine, wheat protein, soya protein, chitosan, aminoplast precondensates or polyamine-polyamide-epichlorohydrin resins.

However, especially for long-aged raw cured sausage types, the sausage emulsion adhesion of such sausage casings is insufficient and this can lead to unwanted detachment of the sausage casing.

### SUMMARY OF THE INVENTION

The purpose of the present invention was then to provide a tubular sausage casing based on cellulose which owing to its special inner coating has an excellent adhesion to the filling, in particular for long-aged raw cured sausage types and can be processed without problems.

This object is achieved by a tubular sausage casing based on cellulose, which is optionally fibre reinforced, having an internally applied coating composition, characterized in that the coating composition contains as adhesion components at least one cationic polymer and at least one protein compound selected from the group consisting of gelatine, soya protein, wheat protein, peanut protein, caseinate and casein, wherein it was surprisingly found that this coating composition effects strong sausage emulsion adhesion in a synergistic manner.

The invention also relates to the use of the sausage casing according to the invention for raw cured sausage and for those sausage types which after their fabrication pass through a production step in which they are heated to at least 50° C.

The invention also relates to the use of the inventive sausage casing for raw cured sausage aged for longer than three weeks, preferably longer than three months.

The invention also relates to the use of the inventive sausage casing for raw cured sausage aged for longer than three months.

### A DETAILED DESCRIPTION OF THE INVENTION

The invention relates to a tubular sausage casing which comprises a cellulose having an internally applied coating composition, wherein the coating composition contains as adhesion component, at least one cationic polymer and at least one protein compound selected from the group consisting of gelatine, soya protein, wheat protein, peanut protein, caseinate and casein.

Suitable cationic polymers which can be used as adhesion component in the present invention include certain heat-curable aldehyde polymers of food quality, such as amino resins, such as, e.g., melamine-formaldehyde polymers. They are commercially available from American Cyanamid under the trade name “ACCOBOND”. ACCOBOND 3524 is, for example, a strongly methylolated melamine-formaldehyde precondensate. Other suitable cationic polymers include the water-soluble, heat-curable, epoxy-substituted polysecondary amine resins. Generally they are condensates of epichlorohydrin and a polyamide. These are oligomers or higher-molecular-weight resin materials having a plurality of secondary amino groups, such as polyamidoamines, polyurea amines and the like. The cationic epoxy-substituted polysecondary amine adhesion agents are preferably condensation products of epichlorohydrin and a polyamine prepolymer which are formed from a dicarboxylic acid, such as adipic acid, glutaric acid and succinic acid, and a diethylenetriamine. Variations of the epoxy-substituted polysecondary amines can be useful adhesion components by modifying the inner structure of diethylenetriamine and/or using alternative dicarboxylic acids as mentioned above. Particularly useful cationic heat-curable adhesion components are commercially available from Hercules, Inc. under the trade name KYMENE®, e.g. Type 557. Such products are also known as Hercules resin 2000 or RESAMINE® which are also water-soluble heat-curable cationic polymers, e.g. reaction products of epichlorohydrin and adipic acid-diethylenetriamine polyamide. Specific examples of suitable resins are polyamine-polyamide resins, polyethyleneimine resins and vinylamine-N-vinylformamide combination resins. Commercial types of such resins are, e.g., KYMENE 557H and KYMENE SLX from Hercules, RESAMINE 3632 and RESAMINE 3608 from Hoechst and LURESIN KTU from BASF.

The cationic polymer selected is, in particular, one or more from the group consisting of polyaminoamides, polyethyleneimines and condensation products thereof with epichlorohydrin. Preferably, cationic polymers are selected which can crosslink to the cellulose surface of the sausage casing since they still have free and correspondingly suitable groups, e.g. chlorohydrin groups and epoxide groupings. A particularly preferably used condensation product is therefore, e.g., polyaminoamide-epichlorohydrin resin. Polyaminoamide-epichlorohydrin resins are already being used for the inner coating of sausage casings and are safe for human health. They are listed in recommendation 44 (artificial sausage skins) of the German Federal Institute for Risk Assessment.

The sausage casing according to the invention preferably contains a fraction of cationic polymer in the coating composition of 0.05 to 0.6% by weight, based on the sausage casing.

The second adhesion component is a protein compound and preferably a natural protein such as casein, gelatine, wheat protein or soya protein. The casein can preferably be present as caseinate.

The fraction of protein compound in the coating composition of the sausage casing according to the invention is preferably 0.01 to 0.15% by weight, based on the sausage casing.

The weight ratio of cationic polymer to protein compound in the coating composition is preferably between 10:1 and 1:10, particularly preferably between 4:1 and 1:4.

In a particularly preferred embodiment of the sausage casing according to the invention, the coating composition comprises as adhesion components at least one mixture of polyaminoamide-epichlorohydrin resin and casein or a mixture of polyaminoamide-epichlorohydrin resin and caseinate. In this case, in particular, preference is given to a mixture of polyaminoamide-epichlorohydrin resin and calcium caseinate.

The weight ratio of polyaminoamide-epichlorohydrin resin to casein or caseinate is preferably between 10:1 and 1:10, particularly preferably between 4:1 and 1:4.

In a preferred embodiment, the coating composition of the sausage casing according to the invention additionally contains one or more release agents. Suitable release agents are, in addition to natural and synthetic oils, e.g. epoxidated natural oils, in particular natural waxes such as carnauba wax, beeswax, candelilla wax and montan wax; mineral release agents such as, e.g., amorphous silica; and also dialkyldiketenes having two C₁₀-C₂₂-alkyl chains. Particular preference is given to carnauba wax because of the safety to foods and the availability of stable dispersions.

If the coating composition contains one or more release agents, their fraction can be 0.01 to 0.12% by weight, based on the sausage casing.

In a preferred embodiment of the invention, the sausage casing is a cellulose fibre skin.

The sausage casing according to the invention can be produced in that an aqueous coating composition as described above is applied to the inside of the sausage casing and the sausage casing is subsequently dried.

In a preferred embodiment of the process according to the invention, an aqueous coating composition containing 1 to 12% by weight of the cationic polymer and/or 0.3 to 3% by weight of the protein compound and optionally 0.2 to 2% by weight of the release agent can be applied to the inside of the sausage casing and the sausage casing can subsequently be dried.

After the sausage casing has been dried, the fraction of the cationic polymer in the coating composition which is applied to the inside of the sausage casing is approximately 40 to 480 mg/m². The amount of protein compound is preferably 12 to 120 mg/m². In the event that a release agent is present in the coating composition, the fraction of release agent in the coating composition which was applied to the inside of the sausage casing after drying of the sausage casing is 8 to 80 mg/m².

The fibre-reinforced sausage casing according to the invention is produced by processes which are known in principle to those skilled in the art. In this case the fibre fleece is shaped to form a tube, coated on both sides with viscose, regenerated in conventional sulphuric-acid-containing precipitation baths, washed, and treated with glycerol as plasticizer. The coating according to the invention on the inside of the regenerated cellulose casing is preferably applied before drying. For this, an aqueous coating composition containing 1 to 12% by weight of the cationic polymer and 0.3 to 3% by weight of the protein compound and optionally 0.2 to 2% by weight of the release agent is charged into the regenerated cellulose tube. The aqueous impregnating solution is held stationary as a liquid bubble by a pinch-roll pair in the regenerated cellulose tube which is passed on continuously in the machine direction, wherein the impregnating solution is applied uniformly to the inner surface. Thereafter, the casing is dried, laid flat and wound up to form reels, wherein the casings according to the invention do not stick together even with relatively long storage and may be opened without problems, for example, in subsequent final processing to form shirred tubing sticks.

The invention finally further relates to the use of the sausage casing according to the invention for producing raw cured sausage, in particular types which are aged for longer than three weeks, preferably longer than one month, particularly preferably longer than two months, and further particularly preferably longer than three months, such as, for example, Hungarian winter salami. The sausage casings according to the invention are also suitable for producing sausage types which, after their fabrication, pass through a production step in which they are heated to at least 500° C., especially if they have a high fat content, such as, e.g., Genoa, which is known in the USA.

### EXAMPLES

The sausage casings of Examples 1 to 5 hereinafter were produced essentially by the abovedescribed process in a nominal calibre 95. In this process in each case a fibre fleece was shaped to form a tube, coated on both sides with viscose, regenerated in a sulphuric-acid-containing precipitation bath, washed and treated with glycerol as plasticizer in order to obtain a corresponding regenerated cellulose tube.

Subsequently the regenerated cellulose tube, without being dried in advance, was treated with the impregnating solution (coating composition) specified in the table below. For this, an aqueous impregnating solution was charged into the regenerated cellulose tube. The figures for contents of the substances in % by weight each represent the mass of the dissolved pure substance based on the mass of the total impregnating solution. Water is used as the solvent for the substances used in Examples 1 to 5 (Table 1). The Plasvita® M used is a water-soluble calcium caseinate having an active ingredient content of 95% by weight (remainder water), produced by Rovita. The polyaminoamide-epichlorohydrin resin used is Kymene® SLX, manufactured by Hercules and having an active ingredient content of 13% by weight (remainder water). The antifoamer used is Neudos® AS23, an alkyl polyalkylene glycol ether from Ochsmann Chemie GmbH, used as an emulsion and having 20% by weight active ingredient content (remainder water).

The aqueous impregnating solution was held stationary as a liquid bubble by a pinch-roll pair in the regenerated cellulose tube which is passed on continuously in the machine direction, wherein the impregnating solution was applied uniformly to the inner surface. Thereafter, the casing was dried, laid flat and wound up to form reels.

Sections of the regenerated cellulose tube were soaked for 30 minutes in hand-hot running water and then sausages of the raw cured sausage type were produced therewith, more precisely described as medium fine-grain salami, produced from 55% by weight of lean tendon-free pork sections having a visible fat content of approximately 5%, 25% by weight of granular fat pork back fat without gristle and 20% by weight of well defatted beef with the tendons thoroughly removed, and also having the further ingredients nitrite curing salt, spice mixture and starter culture. The salami sausages were brought, in an ageing phase, from 23° C. and 94% relative humidity to 16° C. and 82% relative humidity in the course of 7 days, wherein after 3 days they were lightly smoked at approximately 23° C. in cold beech smoke. Subsequent post-ageing was performed in the course of 16 days at 16° C. and 80% relative humidity, wherein after 7 days the sausages were completely smoked in cold smoke.

Thereafter the manual peelability of the sausages was evaluated. The sausage emulsion adhesion was evaluated on a scale of 0 to 5 of increasing adhesion of the sausage casing to the sausage. In the table the mean values of sausage emulsion adhesion of the 3 salami sausages produced in each case per example are reported.

In Examples 1 and 2, of the main components, only the polyaminoamide-epichlorohydrin resin and in Examples 3 and 4, only calcium caseinate were used. The combination of the components in Example 5, owing to the synergistic effect, leads to the significant increase in sausage emulsion adhesion.

TABLE 1
Sausage emulsion adhesion as a function of the composition of the impregnating solution

| Substances in the | Example 1 | Example 2 | Example 3 | Example 4 | Example 5 |
|---|---|---|---|---|---|
| impregnating solution | [% by weight] | [% by weight] | [% by weight] | [% by weight] | [% by weight] |
| Plasvita ® M | | | 1.0 | 5.0 | 1.0 |
| Kymene ® SLX | 5.0 | 8.0 | | | 4.0 |
| Neudos ® AS23 | 0.2 | 0.2 | 0.2 | 0.2 | 0.2 |
| Glycerol | 16.0 | 16.0 | 16.0 | 16.0 | 16.0 |
| Potassium sorbate | 0.2 | 0.2 | 0.2 | 0.2 | 0.2 |
| Sodium hydroxide | 0.1 | 0.1 | 0.1 | 0.1 | 0.1 |
| Sausage emulsion | 2.5 | 2.9 | 1.6 | 2.7 | 3.8 |
| adhesion (mean) | | | | | |

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

All references discussed herein are incorporated by reference in their entirety for all useful purposes.

1. A tubular sausage casing which comprises a cellulose having an internally applied coating composition, wherein the coating composition contains as adhesion component, at least one cationic polymer and at least one protein compound selected from the group consisting of gelatine, soya protein, wheat protein, peanut protein, caseinate and casein.

2. The sausage casing according to claim 1, wherein the cationic polymer is polyaminoamide, polyethyleneimine or a condensation product thereof with epichlorohydrin.

3. The sausage casing according to claim 2, wherein the cationic polymer is polyaminoamide-epichlorohydrin resin.

4. The sausage casing according to claim 2, wherein the fraction of cationic polymer is 0.05 to 0.6% by weight, based on the sausage casing.

5. The sausage casing according to claim 3, wherein the fraction of cationic polymer is 0.05 to 0.6% by weight, based on the sausage casing.

6. The sausage casing according to claim 1, wherein the adhesion component is at least one mixture of polyaminoamide-epichlorohydrin resin and casein or a mixture of polyaminoamide-epichlorohydrin resin and caseinate.

7. The sausage casing according to claim 1, wherein the coating composition additionally comprises at least one release agent.

8. The sausage casing according to claim 7, wherein the fraction of release agent is 0.01 to 0.12% by weight, based on the sausage casing.

9. The sausage casing according to claim 7, wherein said release agent is at least carnauba wax.

10. The sausage casing according to claim 1, wherein the fraction of protein compound is 0.01 to 0.15% by weight, based on the sausage casing.

11. The sausage casing according to claim 1, wherein the sausage casing is a cellulose fibre skin.

12. A process for producing a tubular sausage casing based on cellulose, which comprises applying inside a sausage casing an aqueous coating composition containing as an adhesion component at least one cationic polymer and at least one protein compound selected from the group consisting of gelatine, soya protein, wheat protein, peanut protein, caseinate and casein and subsequently drying the sausage casing.

13. The process according to claim 12, wherein the cationic polymer is polyaminoamide, polyethyleneimine or a condensation product thereof with epichlorohydrin.

14. The process according to claim 13, wherein the cationic polymer is polyaminoamide-epichlorohydrin resin.

15. The process according to claim 13, wherein the fraction of cationic polymer is 0.05 to 0.6% by weight, based on the sausage casing.

16. The process according to claim 14, wherein the fraction of cationic polymer is 0.05 to 0.6% by weight, based on the sausage casing.

17. The process according to claim 12, wherein the adhesion component is at least one mixture of polyaminoamide-epichlorohydrin resin and casein or a mixture of polyaminoamide-epichlorohydrin resin and caseinate.

18. The process according to claim 12, wherein the coating composition additionally comprises at least one release agent.

19. The process according to claim 18, wherein the fraction of release agent is 0.01 to 0.12% by weight, based on the sausage casing.

20. The process according to claim 18, wherein said release agent is at least carnauba wax.

21. The process according to claim 12, wherein the fraction of protein compound is 0.01 to 0.15% by weight, based on the sausage casing.

22. The process according to claim 12, wherein the sausage casing is a cellulose fibre skin.

23. The process according to claim 12, wherein an aqueous coating composition containing 1 to 12% by weight of the cationic polymer and 0.3 to 3% by weight of the protein compound and optionally 0.2 to 2% by weight of the release agent.

24. The sausage casing according to claim 1, which further comprises raw cured sausage or a sausage type which after their fabrication pass through a production step in which they are heated to at least 50° C.

25. The sausage casing according to claim 1, which further comprises raw cured sausage aged for longer than three weeks.

26. The sausage casing according to claim 1, which further comprises raw cured sausage aged for longer than three months.
